(19) United States
(12) Patent Application Publication
(10) Pub. No.: US 2016/0321478 A1
(43) Pub. Date: Nov. 3, 2016

(54) WIRELESS INFORMATION COMMUNICATING TERMINAL AND DEVICE FOR ITS UPDATING

(71) Applicant: BLINKSIGHT, Colombelles (FR)

(72) Inventors: Stéphane Mutz, Cuverville (FR); Matthieu Mutz, Caen (FR)

(73) Assignee: BLINKSIGHT, Colombelles (FR)

(21) Appl. No.: 15/104,346

(22) PCT Filed: Dec. 16, 2014
(86) PCT No.: PCT/EP2014/077952

§ 371 Date: Jun. 14, 2016

(30) Foreign Application Priority Data
Dec. 17, 2013 (FR) 1362825

(51) Int. Cl. G06K 7/10; G06K 19/07; H04B 5/00; G06K 19/077

(52) U.S. Cl. CPC G06K 7/10306; G06K 19/07767; G06K 19/0705; H04B 5/0062

(57) ABSTRACT

The invention relates to a wireless information communicating terminal, comprising a facility for providing a first item of information to the outside, a first receiver able to receive a first signal containing first data according to a first wireless determined communication channel, a control unit for generating the first item of information to be dispatched to the providing facility as a function of the first data received by the first receiver. The invention is characterized in that the terminal furthermore comprises at least one second sender able to send a second signal according to a second wireless determined communication channel of ultra-wide band type.

The invention concerns a wireless information communicating terminal and a device for updating at least one wireless information communicating terminal.

The wireless information communicating terminal may be an electronic shelf label for example, such labels each being intended to be affixed to shelving on which articles are to be arranged for display of their sale price for example e.g.in a store or supermarket. The wireless information communicating terminal may also be a beacon that is to provide wireless information externally and is for example in the vicinity of an object such as a work of art to give information relating thereto.

One of the problems with wireless information communicating terminals is the updating thereof.

For example, with regard to electronic shelf labels all stores are confronted with the problem of price labelling, updating thereof and guaranteeing integrity between the displayed price and the price applied at the cash-out. This operation is time consuming and labour intensive.

Electronic labelling solutions exist and are based on different data transmission technologies. One major constraint for these labels is their self-powering. Solutions that have very low power consumption are therefore required.

Current solutions are therefore limited.

In addition, current solutions only allow little or no interaction.

The frequency of updating is limited to save on the battery life of the labels which prevents the setting up of sales strategies for dynamic price variations.

Additionally it may happen that the wireless information communicating terminals are not suitably positioned relative to the product or shelving.

Evidently the electronic label or wireless information communicating terminal must be removable.

Systems are known using carrier wave or infrared transmission systems but these are highly energy consuming. The transfer of information therein is typically one-way and the frequency of updating is limited. This prevents verification of the proper updating of wireless information communicating terminals, and prevents frequent updating or information feedback (battery level, need for restocking).

The invention sets out to obtain a wireless information communicating terminal and a device for the updating of at least one wireless information communicating terminal which overcome the shortcomings of the prior art.

A further objective of the invention is to provide one or more of the following advantages:

reliable communication with wireless information communicating terminals;

automatic association of wireless information communicating terminals with an item;

long self-sufficiency;

dynamic variation of information provided externally;

possible immediate detection of product shortage for electronic shelving labels.

For this purpose a first subject of the invention is a wireless information communicating terminal comprising a member for the external providing of first information, a first receiver able to receive a first signal containing first data on a first determined wireless communication channel, a control unit to generate the first information to be sent to the providing member as a function of the first data received by the first receiver,

characterized in that the terminal further comprises at least one second transmitter able to transmit a second signal on a second determined wireless communication channel and of Ultra-Wide Band type.

By means of the invention the wireless information communicating terminal can be located at low energy cost and with good reliability. The second signal can also act as acknowledgement of the first data and allows confirmation of the proper updating of the wireless information communicating terminal.

According to one embodiment of the invention, the terminal comprises a memory in which a first identifier of the terminal is recorded, wherein the second signal transmitted by the second transmitter contains the first identifier of the terminal.

According to one embodiment of the invention, the control unit is configured to cause the transmission of the second signal by the second transmitter in response to receipt of the first signal by the first receiver.

According to one embodiment of the invention the first receiver, on the first determined wireless communication channel, is able to receive the first signal containing a second identifier associated with the first data, in addition to the first data.

According to one embodiment of the invention the terminal comprises a memory in which a first identifier of the terminal is recorded,

the first receiver, on the first determined wireless communication channel, is able to receive the first signal containing a second identifier associated with the first data, in addition to the first data;

the control unit comprising means to verify whether the second identifier contained in the first signal received in association with the first data corresponds to the first identifier of the terminal, and means in response to receipt of the first data by the first receiver to cause:

if correspondence,

recording of the first data associated with the second identifier in a memory,

generation of the first information as a function of these first data associated with the second identifier in the memory,

external providing of the first information by the member,

transmission by the second transmitter of the second signal containing at least the first identifier of the terminal and an indication of proper updating of the first data, - if no correspondence, not to cause this recording, this generation, this providing and this transmission.

According to one embodiment of the invention, the first wireless communication channel is of different type to that of the second communication channel.

According to one embodiment of the invention the first wireless communication channel is of optical type.

According to one embodiment of the invention, the first wireless communication channel is of VLC type.

According to one embodiment of the invention the terminal further comprises a third receiver to receive a third trigger signal on a third wireless communication channel, the control unit being configured to set in operation the first receiver for a predetermined time in response to receipt of the third trigger signal by the third receiver and to switch off the first receiver after the predetermined time.

According to one embodiment of the invention the terminal further comprises a third receiver to receive a third trigger signal on a third wireless communication channel, the control unit being configured to set in operation the first receiver for a predetermined time in response to receipt of the third trigger signal by the third receiver and to switch off the first receiver when the first signal has been received by the first receiver.

According to one embodiment of the invention the terminal further comprises a third receiver to receive a third trigger signal on a third wireless communication channel, the control unit being configured to set in operation the first receiver for a predetermined time in response to receipt of the third trigger signal by the third receiver and to switch off the first receiver when the first signal has been received by the first receiver a number of times equal to one or higher.

According to one embodiment of the invention the third communication channel differs from the first communication channel at least in that the third receiver has, for same setting in operation time, lower power consumption than the first receiver.

According to one embodiment of the invention the terminal comprises a fourth transmitter and a fifth receiver, the fourth transmitter being able to transmit a fourth signal containing a second datum on a fourth wireless communication channel of NFC type, in response to the receipt of a fifth interrogation signal by the fifth receiver on the fourth wireless communication channel of NFC type.

According to one embodiment of the invention the terminal comprises a memory able to record second information corresponding to the number of times the fourth transmitter (B4) transmits the fourth signal and/or corresponding to the second datum.

According to one embodiment of the invention the terminal comprises a sixth transmitter able to transmit a sixth signal containing a third datum on a sixth wireless communication channel in the ISM frequency band which may be from 2.4 GHz to 2.485 GHz for example, at instants prescribed in a predetermined time base.

According to one embodiment of the invention, the terminal comprises a seventh receiver on the sixth wireless communication channel in the ISM frequency band which may be from 2.5 GHz to 2.485 GHz for example.

According to one embodiment of the invention the terminal comprises a sixth transmitter and a seventh receiver, the sixth transmitter being able to transmit a sixth signal containing a third datum on a sixth wireless communication channel in the ISM frequency band, which may be from 2.4 GHz to 2.485 GHz for example, in response to receipt of a seventh interrogation signal by the seventh receiver on the sixth wireless communication channel in the ISM frequency band, which may be from 2.4 GHz to 2.485 GHz for example.

According to one embodiment of the invention the terminal comprises a memory in which a first identifier of the terminal and/or third information is recorded, the sixth signal transmitted by the sixth transmitter containing the first identifier of the terminal and/or the third information.

According to one embodiment of the invention the terminal comprises a memory able to record fourth information corresponding to the number of times the sixth transmitter transmits the sixth signal and/or corresponding to the third datum.

According to one embodiment of the invention the second signal also contains the second or fourth information.

According to one embodiment of the invention the terminal comprises means to analyse the fifth and/or seventh interrogation signal received by the fifth and/or seventh receiver to extract therefrom a third identifier of the equipment by which it was transmitted, the second signal also containing this third identifier.

According to one embodiment of the invention the first signal on the first determined wireless communication channel is of Ultra-Wide Band type.

According to one embodiment of the invention the member externally providing the first information is a screen displaying the first information, the control unit being configured to generate the first information to be displayed on the screen as a function of the first data received by the first receiver.

According to one embodiment of the invention the terminal consists of an electronic shelf label.

According to one embodiment of the invention the member externally providing the first information is a wireless transmitter externally transmitting this first information.

According to one embodiment of the invention the member externally providing the first information is the second transmitter capable of externally transmitting the second signal containing the first information on the second determined wireless communication channel and of Ultra-Wide Band type.

According to one embodiment of the invention the member externally providing the first information is the fourth transmitter capable of externally transmitting the fourth signal containing the first information on the fourth wireless communication channel of NFC type.

According to one embodiment of the invention the member externally providing the first information is the sixth transmitter capable of externally transmitting the sixth signal containing the first information on the fourth wireless communication channel in the ISM frequency band which may be from 2.4 GHz to 2.485 GHz for example.

According to one embodiment of the invention the terminal comprises a predetermined time base, the second transmitter and/or fourth transmitter and/or sixth transmitter being able to transmit the second signal and/or fourth signal and/or sixth signal at instants prescribed in the predetermined time base.

According to one embodiment of the invention the second signal and/or fourth signal and/or sixth signal comprise at least one fifth information selected from among:

an indication of low electric power supply level supplied by a self-sufficient power source contained in the terminal;

an indication that a number of transmissions of the second signal and/or fourth signal and/or sixth signal exceeds a pre-recorded threshold in the terminal.

A further subject of the invention is a device for updating at least one wireless information communicating terminal such as described above,

the device comprising at least one first transmitter of the first signal, on the first determined wireless communication channel, to the wireless information communicating terminal,

characterized in that

the device further comprises at least one second receiver to receive the second signal on the second determined wireless communication channel and of Ultra-Wide Band type,

the second receiver being connected to a unit processing the signal received by the second receiver.

According to one embodiment of the invention the second receiver comprises at least one base station which is connected to a localization system allowing calculation of the location of the terminal from the second signal received by the base station.

According to one embodiment of the invention the device comprises at least one eighth transmitter able to transmit a third trigger signal, on the third determined wireless communication channel, to the wireless information communicating terminal, the third trigger signal being able to trigger the setting in operation of the first receiver of the terminal.

According to one embodiment of the invention the device comprises a time base, and the third trigger signal is a signal synchronizing the terminal with the instants prescribed in the time base.

According to one embodiment of the invention the device comprises a ninth transmitter able to transmit to the terminal a fifth interrogation signal on the fourth wireless communication channel of NFC type, and a tenth receiver able to receive a fourth signal containing a second datum from the terminal on the fourth wireless communication channel of NFC type.

According to one embodiment of the invention the devices comprises a twelfth receiver able to receive a sixth signal containing a third datum from the terminal on a sixth wireless communication channel in the ISM frequency band which may from 2.4 GHz to 2.485 GHz for example.

According to one embodiment of the invention the device comprises an eleventh transmitter able to transmit to the terminal a seventh signal on a sixth wireless communication channel in the ISM frequency band, which may be from 2.4 GHz to 2.485 GHz for example.

According to one embodiment of the invention the device comprises an eleventh transmitter able to transmit to the terminal a seventh interrogation signal on the sixth wireless communication channel in the ISM frequency band which may be from 2.4 GHz to 2.485 GHz for example, and a twelfth receiver able to receive from the terminal a sixth signal containing a third datum on the sixth wireless communication channel in the ISM frequency band which may be from 2.4 GHz to 2.485 GHz for example.

The invention will be better understood on reading the following description given solely as a non-limiting example with reference to the appended drawings in which:

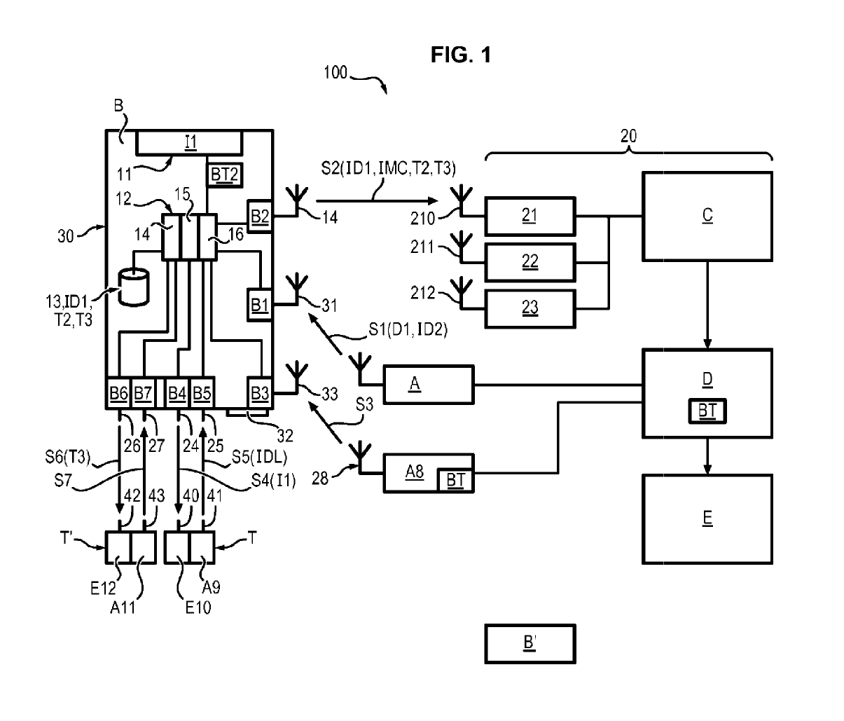

FIG. 1 is a modular synoptic illustration of a wireless information communicating terminal in the form of an electronic shelf label, and a device for updating thereof according to one embodiment of the invention;

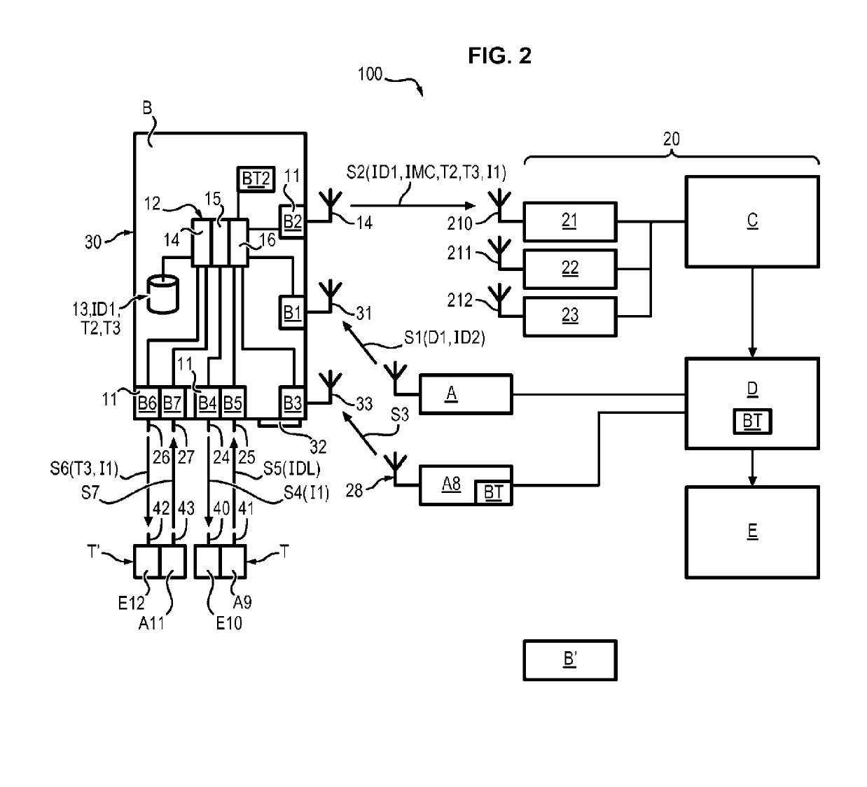

FIG. 2 is a modular synoptic illustration of a wireless information communicating terminal in the form of a communicating beacon, and a device for updating thereof according to another embodiment of the invention.

In FIGS. 1 and 2 a wireless information communicating terminal B is schematically illustrated. The wireless information communicating terminal B comprises a member 11 externally providing first information I1. The wireless information communicating terminal B comprises a first receiver B1 able to receive a first signal S1 containing first data D1 on a first determined wireless communication channel. The wireless information communicating terminal B comprises a control unit 12 to generate the first information I1 to be sent to the providing member 11 as a function of the first data D1 received by the first receiver B1.

According to the invention the wireless information communicating terminal B also comprises at least one second transmitter B2 able to transmit a second signal S2 on a second determined wireless communication channel of UWB type (Ultra-Wide Band).

The receiver B1 is equipped for example with one or more antennas 31 used to receive signal S1 via wireless radio link. The wireless information communicating terminal B may comprise a casing 30 in which the electronic parts are housed forming one, some, several or all elements 11, 12, 13, 14, 15, 16, B1, B2, B3, B4, B5, B6, B7, 31, 33, 24, 25, 26, 27, BT2 which are described below. The wireless information communicating terminal B can be equipped with one or more attaching elements 32, that are removable for example, enabling it to be removably attached to a support which is separate from the label B, this or these attaching elements 32 being attached to the casing 30 or being one piece with this casing 30.

In the embodiment in FIG. 1, the member 11 externally providing the first information I1 is or comprises a screen 11 displaying the first information I1, the control unit 12 being designed to generate the first information I1 to be displayed on the screen 11 as a function of the first data D1 received by the first receiver B1. For example, the wireless information communicating terminal B is or comprises an electronic shelf label B. The label B is intended to be affixed or attached to a shelf or compartment (globally designated a support) that is to contain articles, goods or objects e.g. to display information which may comprise a sale price or other information, this information being globally designated I1.

In the embodiment in FIG. 2, the member 11 externally providing the first information I1 is or comprises a wireless transmitter B2 and/or B4 and/or B6 externally transmitting this first information I1.

For example in the embodiment in FIG. 2 the member 11 externally providing the first information I1 is or comprises the second transmitter B2 able to transmit to the outside the second signal S2 containing the first information I1 on the second determined wireless communication channel and of Ultra-Wide Band type.

For example in the embodiment in FIG. 2 the member 11 externally providing the first information I1 is or comprises the fourth transmitter B4 able to transmit to the outside the fourth signal S4 containing the first information I1 in the fourth wireless communication channel of NFC type.

For example in the embodiment in FIG. 2 the member 11 externally providing the first information I1 is or comprises the sixth transmitter B6 able to transmit to the outside the sixth signal S6 containing the first information I1 on the fourth wireless communication channel in the ISM frequency band which may be from 2.4 GHz to 2.485 GHz for example.

In the embodiment in FIG. 2 the wireless information communicating terminal B is or comprises for example a beacon B which has to provide wirelessly the information I1 to the outside, by being affixed for example close to an object which may be a work of art for example (painting, sculpture of other) to give information on this object, the information I1 transmitted externally via wireless by the transmitter B2 and/or B4 and/or B6 possibly having an educational and/or cultural and/or practical and/or recreational and/or geolocation content.

In the embodiment in FIG. 2 the wireless information communicating terminal B, as member 11 externally providing information I1, does not have a display screen for example.

In FIGS. 1 and 2 the information I1 is intended to be conveyed to a human being via any means in FIG. 1 for example a screen 11 of terminal B, or in FIGS. 1 and 2 a telecommunications terminal 20 and/or T and/or T′ which is separate from terminal B and which has received the information I1 from transmitter B2 and/or B4 and/or B6 of this terminal B, the information I1 possibly being conveyed to a human being on terminal 20 and/or T and/or T′ via a visual and/or sound and/or olfactory interface so that it can be perceived by a human being equipped with this terminal. The information I1 is human information I1.

Embodiments of the invention are described below with reference to FIGS. 1 and 2.

According to one embodiment the second signal S2 transmitted by the second transmitter B2 contains a first identifier ID1 of terminal B, this first identifier ID1 being recorded in a memory 13 of the terminal B.

The device 100 to update the electronic shelf label B comprises at least a first transmitter A to transmit the first signal S1, on the first determined wireless communication channel, to the wireless information communicating terminal B. The updating device 100 further comprises at least one second receiver 20, C, 21, 22, 23 to receive the second signal S2 on the second determined wireless communication channel of Ultra-Wide Band type. The second receiver 20 is connected to a unit D processing the signal S2 received by the second receiver 20. The updating device 100 is particularly designed to update the information I1 that is to be provided to the outside by the member 11 of terminal B. Evidently the updating device 100 can be designed to update several wireless information communicating terminals B, B′ by exchanging signals described below therewith, the wireless information communicating terminals B, B′ being separate from one another and distant from one another having the means described for the wireless information communicating terminal B. The transmitter A is connected to system D for example via a wire link.

According to one embodiment, the second receiver 20 comprises at least one base station 21, 22, 23 which is connected to a localization system C allowing the calculation, from the second signal S2 received by the base station 21, 22, 23, of the location of the wireless information communicating terminal B. The receiver 20 and the base station(s) 21, 22, 23 are at a distance from the wireless information communicating terminal B. In addition the base stations 21, 22, 23 are distant from one another.

In one embodiment the receiver 20 and the base station(s) 21, 22, 23 are fixed and are arranged for example in a building which may be a warehouse, store, supermarket, museum, exhibition hall or other.

According to one embodiment the transmitter B2 is a wireless radio transmitter and is for example a transmitter of RFID type. The transmitter B2 is able to transmit the second signal S2 from a distance of several metres to the receiver 20 and/or base station(s) 21, 22, 23.

The second signal S2 is an impulse signal for example. The transmitter B2 in one embodiment may be an impulse radio transmitter. The second determined wireless communication channel of Ultra-Wide Band type conforms to standard IEEE802.15.4a for example. The wireless transmitter B2 is equipped for example with one or several antennas 14 used to send the second signal S2 via wireless radio link to the receiver 20 and/or to the base station(s) 21, 22, 23.

The second signal S2 allows determination of the location of the wireless information communicating terminal B in relation to at least one coordinate. For example in one embodiment the wireless information communicating terminal B is equipped with the transmitter B2 that can be located in two or three dimensions by the base station(s) 21, 22, 23 by means of the second signal S2 sent by the transmitter B2 to the base stations 21, 22, 23. The wireless information communicating terminal B is therefore locatable within accuracy of less than 10 centimetres.

For example at least two base stations 21, 22 are provided distant from one another so that it is possible to locate the transmitter B2 at least in two dimensions and thereby the wireless information communicating terminal B. For example at least three base stations 21, 22, 23 are provided at nonaligned positions for example for the three-dimensional locating of the transmitter B2 and hence of the wireless information communicating terminal B. A single base station 21 may also be provided for example comprising a system to measure the angle of arrival of the second signal S2. The base station(s) 21, 22, 23 and the localization system 30 are for example part of a Real Time Localization System (RTLS).

Therefore system C from the second signal S2 calculates the location of the wireless information communicating terminal B. Each base station 21, 22, 23 and/or each receiver 20 is also equipped with at least one antenna 210, 211, 212 to allow receiving of the second signal S2 transmitted by the transmitter B2.

With regard to an electronic shelf label B, the data processing system D allows the linking of the location of label B with a storage area of objects or goods, namely the shelf or area in which the label B is arranged and where objects, products or articles are stored. This data processing system D is a price and/or stock management system for example. With system D it is possible to vary the information I1 to be externally displayed by the screen 11 of the electronic shelf label B by sending various data D1 in signal S1.

With regard to a beacon B in FIG. 2, the system D allows the locating and identification of each beacon B. System D allows varying of the information I1 which is to be externally transmitted by transmitter B2 and/or B4 and/or B6 of the wireless communicating terminal B, by the fact that the device 100 sends various data D1 in signal S1.

According to one embodiment, the control unit 12 of the wireless information communicating terminal B is configured to cause the transmission of the second signal S2 by the second transmitter B2 in response to receiving of the first signal S1 by the first receiver B1. Therefore the second signal S2 transmitted by the second transmitter B2 acts as acknowledgement of the first signal S1.

According to one embodiment the first receiver B1, on the first determined wireless communication channel, is able to receive the first signal S1 which in addition to the first data D1 contains a second identifier ID2 associated with the first data D1.

For example, according to this embodiment the control unit 12 comprises means to verify whether the second identifier ID2 contained in the first signal S1 received in association with the first data D1 corresponds to the first identifier ID1 of the wireless information communicating terminal B.

According to this embodiment the control unit 12 comprises means 14 to verify whether the second identifier ID2 contained in the first signal S1 received in association with the first data D1 corresponds to the first identifier ID1 of terminal B and means 15, in response to receiving of the first data D1 by the first receiver B1, to cause:

if correspondence,

recording of the first data D1 associated with the second identifier ID2 in a memory 13,

generation of the first information I1 as a function of these first data D1 associated with the second identifier ID2 in the memory 13,

providing of the first information I1 by the member 11 to the outside,

transmission by the second transmitter B2 of the second signal S2 containing at least the first identifier ID1 of the terminal B and an indication IMC of proper updating of the first data D1,

if no correspondence, not to cause this recording, this generation, this providing and this transmission.

According to one embodiment the first wireless communication channel is of different type to the second wireless communication channel.

According to one embodiment, the first transmitter A, the first receiver B1 and the first communication channel are of radio type. For example the first receiver B1 is a low-energy radio receiver.

The use of the second transmitter B2 in the second wireless communication channel of Ultra-Wide Band type as feedback path S2 has the triple advantage of allowing confirmation of the status of terminal B and success of the updating thereof, the locating of terminal B and the limiting of power consumption by terminal B for these functions.

The wireless information communicating terminal B comprises a self-sufficient electric supply source for example in the form of a battery or power collecting system, this source or this system enabling the wireless information communicating terminal B to be electrically powered without a wire connection to an electricity network.

According to one embodiment the first transmitter A, the first receiver B1 and the first wireless communication channel are of radio type for example ISM at 433 MHz or 900 MHz.

According to another embodiment the first transmitter A, the first receiver B1 and the first wireless communication channel are of optical type.

According to another embodiment the first transmitter A uses a modulator of visible or infrared light to send the first signal Sl. For example, in visible light the first communication channel is of VLC type (Visible Light Communication type).

According to one example of embodiment the first transmitter A comprises a visible light modulator to modulate the light sent by at least one illuminating device comprising one or more neon or light bulbs for example) to send the first signal S1.

According to one embodiment the wireless information communicating terminal B further comprises a third receiver B3 to receive a third trigger signal S3 on a third wireless communication channel, the control unit being configured to set the first receiver B1 in operation for a predetermined time in response to receiving of the third trigger signal S3 by the third receiver B3, and to switch off the first receiver B1 after the predetermined time. Therefore the third receiver B3 is used to signal to label B the imminent arrival of the first signal S1 carrying the first data D1 via another transmission mode.

According to one embodiment, the wireless information communicating terminal B further comprises a third receiver B3 to receive a third trigger signal S3 on a third wireless communication channel, the control unit being configured to set the first receiver B1 in operation for a predetermined time in response to the receiving of the third trigger signal S3 by the third receiver B3, and to switch off the first receiver B1 when the first signal S1 has been received by the first receiver B1.

According to one embodiment the wireless information communicating terminal B further comprises a third receiver B3 to receive a third trigger signal S3 on a third wireless communication channel, the control unit being configured to set the first receiver B1 in operation for a predetermined time in response to the receiving of the third trigger signal S3 by the third receiver B3, and to switch off the first receiver B1 when the first signal S1 has been received by the first receiver B1 a number of times equal to one or higher.

According to one embodiment the third communication channel differs from the first communication channel at least in that the third receiver B3, for same setting in operation time, consumes lesser power than the first receiver B1. The updating device 100 comprises for example a transmitter A8 able to transmit the third signal S3 on the third wireless communication channel. The third signal S3 is therefore a trigger or wake-up signal for the first receiver B1. The transmitter A8 is equipped for example with one or more antennas 28 used to send signal S3 via wireless radio link to the receiver B3. The receiver B3 is provided for example with one or more antennas 33 used to receive signal S3 via wireless radio link. The transmitter A8 is connected to system D, for example by a wire link.

In one embodiment, the third transmitter A8 comprises a time base BT or clock BT and the third trigger signal S3 transmitted by the eighth transmitter A8 is a synchronisation signal of the wireless information communicating terminal B with prescribed instants in the time base BT or clock BT.

This synchronisation signal allows determination of the instant at which the first receiver B1 is to be set in operation (i.e. set in listening mode) for an update sent by the first signal Si. The time base BT or clock BT can be provided for example in the processing system D connected to the eighth transmitter A8.

According to one embodiment the wireless information communicating terminal B comprises a fourth transmitter B4 and a fifth receiver B5, the fourth transmitted B4 being able to transmit a fourth signal S4 containing a second datum T2 on a fourth wireless communication channel of NFC type in response to the receiving of a fifth interrogation signal S5 by the fifth receiver B5 on the fourth wireless communication channel of NFC type. NFC is the abbreviation for Near Field Communication.

According to one embodiment the wireless information communicating terminal B comprises a memory 13 capable of recording second information T2 corresponding to the number of times T2 the fourth transmitter B4 transmits the fourth signal S4 and/or corresponding to the second datum T2.

According to one embodiment, the updating device 100 comprises a ninth transmitter A9 able to transmit the fifth interrogation signal S5, on the fourth wireless communication channel of NFC type, to the fifth receiver B5 of the wireless information communicating terminal B and also comprises a tenth receiver E10 which, on the fourth wireless communication channel of NFC type, is able to receive from terminal B the fourth signal S4 containing the second datum T2 sent by the fourth transmitter B4 of the terminal. The transmitter B4 is equipped for example with one or more antennas 24 used to send signal S4 to the receiver E10 via wireless radio link. The transmitter A9 and the receiver E10 are connected to system D for example via a wireless link which is not of NFC type. The transmitter A9 and/or receiver E10 is contained in the casing of a mobile terminal T for example (e.g. a mobile telephone or wireless terminal) separate from another casing housing the other elements (C, D, 21, 22, 23, . . . ) of device 100.

The receiver E10 is equipped for example with one or more antennas 40 used to receive signal S4 via wireless radio link. The transmitter A9 is equipped for example with one or more antennas 41 used to send signal S5 via wireless radio link to the receiver B5. The receiver B5 is equipped for example with one or more antennas 25 used to receive signal S5 via a wireless radio link.

For example, the ninth transmitter A9 and the tenth receiver E10 are part of the wireless mobile terminal T, e.g. a mobile telephone T or mobile reader T or other. This terminal T is therefore of NFC type. With regard to an electronic shelf label B, when a goods item is taken from the shelf on which the label B is affixed, the client can scan the label using terminal T by sending signal S5 and receiving signal S4 to generate transaction datum T2. This transaction datum T2 may be recorded and/or counted by label B. If the transaction datum T2 is recorded in the memory 13, the label can transfer the transaction datum T2 to the device 100 in the second signal S2 in association for example with an identifier IDL of terminal T comprising the receiver A9 and transmitter E10 and/or the time of transmission or receipt by terminal T (date and/or time for example). In the case when the number of times T2 the fourth transmitter B4 transmits the fourth signal S4 is computed by label B, label B can communicate this computed number T2 of goods or products taken from the shelf, this number T2 being contained in the signal S2 sent. This information T2 can allow the anticipation of a product shortage and faster optimising of restocking management.

For example, the terminal T of NFC type enables clients to record their purchase on their terminal or intended purchase by saving the information contained is the fourth signal S4 which may contain the first information I1 and/or first data D1. In addition, the fifth signal S5 may contain a third identifier IDL of the transmitter A9 or of the terminal T or equipment T containing the same and/or an identifier IDL pre-recorded in this terminal T that may possibly also be an identifier IDL of the person using this terminal T or equipment T.

According to one embodiment, the wireless information communicating terminal B comprises a sixth transmitter B6 able to transmit a sixth signal S6 containing a third datum T3 on a sixth wireless communication channel in the ISM frequency band, which may be for example from 2.4 GHz to 2.485 GHz at prescribed instants in a predetermined time base BT2.

According to one embodiment the wireless information communicating terminal B comprises a seventh receiver B7 on the sixth wireless communication channel in the ISM frequency band, which may be for example from 2.4 GHz to 2.485 GHz.

According to one embodiment, the wireless information communicating terminal B comprises a sixth transmitter B6 and a seventh receiver B7, the sixth transmitter B6 being able to transmit a sixth signal S6 containing a third datum T3 on a sixth wireless communication channel in the ISM frequency band, which may be for example from 2.4 GHz to 2.485 GHz, in response to the receiving of a seventh interrogation signal S7 by the seventh receiver B7 on the sixth wireless communication channel in the ISM frequency band which may be from 2.4 GHz to 2.485 GHz for example. The sixth transmitter B6, the seventh receiver B7 and the sixth communication channel are of short range type for example e.g. having a range between 1 and 50 metres or between 1 and 10 metres, and may be of Bluetooth type for example (registered trademark) in particular Bluetooth LE or BLE.

According to one embodiment the wireless information communicating terminal B comprises a memory 13 in which a first identifier ID1 of the wireless information communicating terminal B and/or third information is recorded, the sixth signal S6 transmitted by the sixth transmitter B6 containing the first identifier ID1 of the wireless information communicating terminal B and/or the third information.

According to one embodiment the wireless information communicating terminal B comprises a memory 13 able to record fourth information T3 corresponding to the number of times T3 the sixth transmitter B6 transmits the sixth signal S6 and/or corresponding to the third datum T3.

According to one embodiment the second signal S2 also contains the second or fourth information T2, T3.

According to one embodiment the wireless information communicating terminal B comprises means 16 to analyse the fifth and/or seventh interrogation signal S5, S7 received by the fifth and/or seventh receiver B5, B7 to extract therefrom the third identifier IDL of the equipment A4, A6 by which it was transmitted, wherein the second signal S2 also contains this third identifier IDL.

According to one embodiment the updating device 100 comprises a twelfth receiver E12 able to receive a sixth signal S6 containing a third datum T3 from the wireless information communicating terminal B on a sixth wireless communication channel in the ISM frequency band which may be from 2.4 GHz to 2.485 GHz for example.

According to one embodiment, the updating device 100 comprises an eleventh transmitter A11 able to transmit a seventh signal S7, on a sixth wireless communication channel in the ISM frequency band which may be from 2.4 GHz to 2.485 GHz for example, to the wireless information communicating channel B.

According to one embodiment the updating device 100 comprises an eleventh transmitter A11 able to transmit a seventh interrogation signal S7, on the sixth wireless communication channel of ISM frequency band which may be from 2.4 GHz to 2.485 GHz for example, to the wireless information communicating terminal B, and a twelfth receiver E12 able to receive a sixth signal S6 containing a third datum T3 from the wireless information communicating terminal B on the sixth wireless communication channel in the ISM frequency band, which may be for example from 2.4 GHz to 2.485 GHz.

The transmitter B6 is equipped for example with one or more antennas 26 used to send signal S6 via wireless radio link to receiver E12. Receiver E12 is equipped for example with one or more antennas 42 used to receive signal S6 via wireless radio link. Transmitter A11 is equipped for example with one or more antennas 43 used to send signal S7 via wireless radio link to receiver B7. For example receiver B7 is equipped with one or more antennas 27 used to receive signal S7 via wireless radio link. The transmitter A11 and receiver E12 are connected to system D for example via a wire link.

The transmitter A is used to transmit an update D1 of the information contained in and/or to be displayed by the wireless information communicating terminal(s) B. The flow of information S1 and/or S3 is broadcast by transmitter A and/or transmitter A8 to a wireless information communicating terminal B or to several wireless information communicating terminals B, B′. The first signal S1 contains the identifier ID2 and the first data D1. The identifier ID2 may optionally correspond to several wireless information communicating terminals B, B′ i.e. it is the same as identifier ID1 recorded in several different wireless information communicating terminals B, B′.

The response S2 of the wireless information communicating terminal B to signal S1 is sensed by the receiver 20 which locates the source of transmission of each signal S2, namely the wireless information communicating terminal B, and therefore determines the coordinates of each wireless information communicating terminal B. The localization information obtained by the localization system D is also used for example to verify that no positioning error of the wireless information communicating terminal B has been made.

At a configuration phase, the transmitter A can interrogate the wireless information communicating terminals B via signal S1 so that the updating device 100 can collect the coordinates of the wireless information communicating terminals B and compare these coordinates with a database E describing the organisation of shelving or items on which or close to which the wireless information communicating terminals B are attached. The database E is a memory recording the identifiers ID1 of the wireless information communicating terminals B in association with the coordinates of the position at which the wireless information communicating terminals B is located, and optionally in association with other information e.g. on the item, product or goods that are to be found at this position, the information I1 possibly being a price, description or other for example. On the basis of this comparison system D can automatically associate the identifier ID1 of the wireless information communicating terminal B with an item, product or goods.

With regard to an electronic shelf label B, the association of time information with a transaction (e.g. transaction whereby a client has taken a product from a shelf) also allows validation of the price of the product in the event of dynamic price changing (for example for flash sales or special offer periods). Therefore the transaction information T2, T3 may comprise time information. The price could also be automatically adjusted after an event (e.g. special price for a limited product quantity). Provision can therefore be made for marking the time a product is taken by a client (e.g. flash sale i.e. during a limited time period).

According to one embodiment the first signal S1 on the first determined wireless communication channel is of Ultra-Wide Band type. According to one embodiment the terminal B could also itself decide to transmit information in accordance with a predetermined time base BT2 particular to the terminal. According to one embodiment, the wireless information communicating terminals B comprises a predetermined time base BT2, the second transmitter B2 and/or fourth transmitter B4 and/or sixth transmitter B6 being able to transmit the second signal S2 and/or fourth signal S4 and/or sixth signal S6 at prescribed instants in the predetermined time base BT2.

For example the instants are periodical in the time base BT2 and/or BT.

According to one embodiment the terminal B could also return a message following the occurrence of an event:

low battery

number of transactions exceeding a predetermined threshold (e.g.

programmed in terminal B).

According to one embodiment the second signal S2 and/or fourth signal S4 and/or sixth signal S6 comprise at least a fifth item of information selected from among:

an indication of low electric power provided by a self-powering supply source contained in the wireless information communicating terminal B,

an indication that a number of transmissions of the second signal S2 and/or fourth signal S4 and/or sixth signal exceeds a threshold pre-recorded in the wireless information communicating terminal B.

1. A wireless information communicating terminal comprising a member externally providing first information, a first receiver of Ultra-Wide Band type able to receive a first signal containing first data on a first determined wireless communication channel of Ultra-Wide Band type, a control unit to generate the first information to be sent to the member as a function of the first data received by the first receiver,
the wireless information communicating terminal further comprising at least one second transmitter able to transmit a second signal on a second determined wireless communication channel of Ultra-Wide Band type,
the control unit being configured to cause the transmission of the second signal by the second transmitter in response to receiving of the first signal by the first receiver,
wherein the wireless information communicating terminal further comprises a third receiver to receive a third trigger signal on a third wireless communication channel, the control unit being configured in response to receipt of the third trigger signal by the third receiver to set in operation the first receiver of Ultra-Wide Band type for a predetermined time so that the first receiver of Ultra-Wide Band receives the first signal containing first data on the first determined wireless communication channel of Ultra-Wide Band type,
the third communication channel differing from the first communication channel at least in that the third receiver, for same setting in operation time, has lower power consumption than the first receiver.

2. The terminal according to claim 1, comprising a memory in which a first identifier of the wireless information communicating terminal is recorded, wherein the second signal transmitted by the second transmitter contains the first identifier of the wireless information communicating terminal.

3. The terminal according to claim 1, wherein the first receiver on the first determined wireless communication channel is able to receive the first signal which, in addition to the first data, contains a second identifier associated with the first data.

4. The terminal according to claim 1, comprising a memory in which a first identifier of the terminal is recorded,
wherein the first receiver on the first determined wireless communication channel is able to receive the first signal which, in addition to the first data, contains a second identifier associated with the first data,
the control unit comprising means to verify whether the second identifier contained in the first signal received in association with the first data corresponds to the first identifier of the wireless information communicating terminal, and means in response to receipt of the first data by the first receiver to cause:
if correspondence,
recording of the first data associated with the second identifier in a memory,
generation of the first information as a function of these first dataassociated with the second identifier in the memory,
providing of the first information by the member to the outside,
transmission by the second transmitter of the second signal containing at least the first identifier of the wireless information communicating terminal and an indication of proper updating of the first data,
if no correspondence, not to cause this recording, this generation, this providing and this transmission.

5. The terminal according to claim 1, wherein the control unit is configured to switch off the first receiver after the predetermined time.

6. The terminal according to claim 1, wherein the control unit is configured to switch off the first receiver when the first signal has been received by the first receiver.

7. The terminal according to claim 1, wherein the control unit is configured to switch off the first receiver when the first signal has been received by the first receiver a number of times equal to one or higher.

8. The terminal according to claim 1, comprising a fourth transmitter and a fifth receiver, wherein the fourth transmitter being is able to transmit a fourth signal containing a second datum on a fourth wireless communication channel of NFC type, in response to the receipt of a fifth interrogation signal by the fifth receiver on the fourth wireless communication channel of NFC type.

9. The terminal according to claim 8, wherein the terminal comprises a memory able to record second information corresponding to the number of times the fourth transmitter transmits the fourth signal and/or corresponding to the second datum.

10. The terminal according to claim 1, comprising a sixth transmitter able to transmit a sixth signal containing a third datum on a sixth wireless communication channel in an ISM frequency band at instants prescribed in a predetermined time base.

11. The terminal according to claim 1, comprising a seventh receiver on the sixth wireless communication channel in an ISM frequency band.

12. The terminal according to claim 1, comprising a sixth transmitter and a seventh receiver, wherein the sixth transmitter being able to transmit a sixth signal containing a third datum on a sixth wireless communication channel in an ISM frequency band, in response to the receiving of a seventh interrogation signal by the seventh receiver on the sixth wireless communication channel in an ISM frequency band.

13. The terminal according to claim 10, comprising a memory in which a first identifier of the wireless information communicating terminal and/or third information is recorded, the sixth signal transmitted by the sixth transmitter containing the first identifier of the wireless information communicating terminal and/or the third information.

14. The terminal according to claim 10, comprising a memory able to record fourth information corresponding to the number of times the sixth transmitter transmits the sixth signal and/or corresponding to the third datum.

15. The terminal according to claim 9 or 14, wherein the second signal also contains the second or fourth information.

16. The terminal according to claim 8, comprising means to analyse the fifth and/or seventh interrogation signal received by the fifth and/or seventh receiver to extract therefrom a third identifier of the equipment by which it was transmitted, the second signal also containing this third identifier.

17. The terminal according to claim 1, wherein the member externally providing the first information is a screen to display the first information, the control unit being designed to generate the first information to be displayed on the screen as a function of the first data received by the first receiver.

18. The terminal according to claim 17, wherein it consists of an electronic shelf label.

19. The terminal according to claim 1, wherein the member externally providing the first information is a wireless transmitter transmitting this first information to the outside.

20. The terminal according to claim 1, wherein the member externally providing the first information is the second transmitter capable of transmitting to the outside the second signal containing the first information on the second determined wireless communication channel of Ultra-Wide Band type.

21. The terminal according to claim 8, wherein the member externally providing first information is the fourth transmitter capable of transmitting to the outside the fourth signal containing the first information on the fourth wireless communication channel of NFC type.

22. The terminal according to claim 10 wherein the member externally providing the first information is the sixth transmitter capable of transmitting to the outside the sixth signal containing the first information on the fourth wireless communication channel in an ISM frequency band.

23. The terminal according to claim 1, comprising a predetermined time base, the second transmitter and/or fourth transmitter and/or sixth transmitter being able to transmit the second signal and/or fourth signal and/or sixth signal at instants prescribed in the predetermined time base.

24. The terminal according to claim 1, wherein the second signal and/or fourth signal and/or sixth signal comprises at least one fifth information selected from among:
an indication of low electric power supply level supplied by a self-sufficient power source contained in the wireless information communicating terminal,
an indication that a number of transmissions of the second signal and/or fourth signal and/or sixth signal exceeds a threshold pre-recorded in the wireless information communicating terminal.

25. A device for updating at least one wireless information communicating terminal according to claim 1,
the device comprising at least one first transmitter for transmitting of the first signal, on the first determined wireless communication channel of Ultra-Wide Band type, to the wireless information communicating terminal,
the device further comprising at least one second receiver to receive the second signal on the second determined wireless communication channel of Ultra-Wide Band type,
the second receiver being connected to a unit processing the signal received by the second receiver,
wherein it comprises at least one eighth transmitter able to transmit a third trigger signal on the third determined wireless communication channel to the wireless information communicating terminal the third trigger signal being able to trigger the setting in operation of the first receiver of Ultra-Wide Band type of wireless information communicating terminal so that the first receiver ofUltra-Wide Band type receives the first signal containing first data on the first determined wireless communication channel of Ultra-Wide Band type,
the third communication channel differing from the first communication channel at least in that the third receiver, for same setting in operation time, has lower power consumption than the first receiver.

26. The device according to claim 25, wherein the second receiver comprises at least one base station that is connected to a localization system allowing the calculation, from the second signal received by the base station, of the location of the wireless information communicating terminal.

27. The device according to claim 25 or 26, wherein it comprises a time base and the third trigger signal is a synchronisation signal of wireless information communicating terminal with instants prescribed in the time base.

28. The device according to claim 25, wherein it comprises a ninth transmitter able to transmit a fifth interrogation signal on the fourth wireless communication channel of NFC type to the wireless information communicating terminal, and a tenth receiver able to receive a fourth signal containing a second datum from wireless information communicating terminal on the fourth wireless communication channel of NFC type.

29. The device according to claim 25, wherein it comprises a twelfth receiver able to receive a sixth signal containing a third datum from wireless information communicating terminal on a sixth wireless communication channel in an ISM frequency band.

30. The device according to claim 25, wherein it comprises an eleventh transmitter able to transmit a seventh signal, on a sixth wireless communication channel in an ISM frequency band, to the wireless information communicating terminal.

31. The device according to claim 25, wherein it comprises an eleventh transmitter able to transmit a seventh interrogation signal on the sixth wireless communication channel in an ISM frequency band to the wireless information communicating terminal, and a twelfth receiver able to receive a sixth signal containing a third datum from the wireless information communicating terminal on the sixth wireless communication channel in the ISM frequency band.
